(19) United States
(12) Patent Application Publication
(10) Pub. No.: US 2015/0060378 A1
(43) Pub. Date: Mar. 5, 2015

(54) FISHING ROD AND REEL CARRIER

(71) Applicant: Daniel M. Bestor, Vermilion, OH (US)

(72) Inventor: Daniel M. Bestor, Vermilion, OH (US)

(21) Appl. No.: 14/013,142

(22) Filed: Aug. 29, 2013

(51) Int. Cl. A47B 81/00; F16B 47/00

(52) U.S. Cl. CPC A47B 81/005; F16B 47/00
USPC 211/70.8; 248/206.5; 248/205.5

(57) ABSTRACT

A fishing rod and reel carrier for transporting and mounting one or more fishing rods and reels includes a carrier frame which mounts on a ferromagnetic surface. A plurality of fishing rod holders are mounted to the frame. A plurality of suction cups are secured to the frame to removably adhere the frame to the ferromagnetic surface. A plurality of magnets are secured to the frame to removably attach to the ferromagnetic surface to aid in keeping the suction cups affixed to the ferromagnetic surface.

### FIELD OF THE INVENTION

The present invention relates generally to a fishing rod and reel carrier. More specifically, the present invention relates to a fishing rod and reel carrier that can be easily mounted to a vehicle and then removed and mounted on a wall.

### BACKGROUND OF THE INVENTION

Fishing is a very popular and exciting sport. Fishermen often take several rods with reels attached thereto with them when they go fishing. This can be for the purpose of providing a fishing pole outfit for each person in the fishing party, but quite often it is for the purpose of having different rod and reel combinations available for different fishing conditions, or, as in the case of a tournament fisherman, for quickly switching from one lure to another by merely grabbing a different rod and reel outfit. One of the main challenges when planning a fishing trip is carrying fishing poles to and from the desired fishing spot, particularly when transport with an automobile is required. The problem is exacerbated when bringing multiple rods on fishing excursions. The rods are long and flexible. The reels are somewhat fragile.

When a person is attempting to move several fishing rods from one location to another, that person in the past has had relatively few options. The most common practice is to remove the reels from the rods and to break down and store the rods in individual carrying cases. Another alternative is simply to leave the reels on the rods and to carry the rods together or stack them together. The disadvantage of the latter approach is the chance that someone will step on the rods or that the rods and reels will be damaged by striking one another. Persons that fish extensively have a need for a convenient means for carrying their fishing rods in their vehicles. For short trips, it would be particularly convenient if the rods could be carried in an assembled condition. But when assembled, their lengths may prevent them from being carried inside the vehicle.

### SUMMARY OF THE INVENTION

According to an embodiment of the present invention, there is disclosed a fishing rod and reel carrier for transporting and mounting one or more fishing rods and reels. The carrier includes a carrier frame which mounts on a ferromagnetic surface. A plurality of fishing rod holders are mounted to the frame. A plurality of suction cups are secured to the frame to removably adhere the frame to the ferromagnetic surface. A plurality of magnets are secured to the frame to removably attach to the ferromagnetic surface to aid in keeping the suction cups affixed to the ferromagnetic surface.

According to another embodiment of the present invention, a method of transporting and mounting one or more fishing rods and reels on a fishing rod and reel carrier includes: mounting a carrier frame on a ferromagnetic surface; providing a plurality of fishing rod holders mounted to the frame; removably adhering the frame to the ferromagnetic surface with a plurality of suction cups secured to the frame; and removably attaching the frame to the ferromagnetic surface with a plurality of magnets secured to frame to aid in keeping the suction cups affixed to the ferromagnetic surface.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 is a front, three-dimensional view of a fishing rod and reel carrier, in accordance with the present invention.

FIG. 2 is a top view of a fishing rod and reel carrier, in accordance with the present invention.

FIG. 3 is a bottom view of a fishing rod and reel carrier, in accordance with the present invention.

FIG. 4 is a side view of a fishing rod and reel carrier, in accordance with the present invention.

FIG. 5 is a rear view of a fishing rod and reel carrier, in accordance with the present invention.

FIG. 6 is a front, three-dimensional view of a fishing rod and reel carrier mounted to the roof of a vehicle, in accordance with the present invention.

FIG. 7 is a front, three-dimensional view of a fishing rod and reel carrier mounted to a wall, in accordance with the present invention.

FIG. 8 is a front, three-dimensional view of a magnet support housing, in accordance with the present invention.

FIG. 9 is a cross-sectional view of a magnet support housing, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

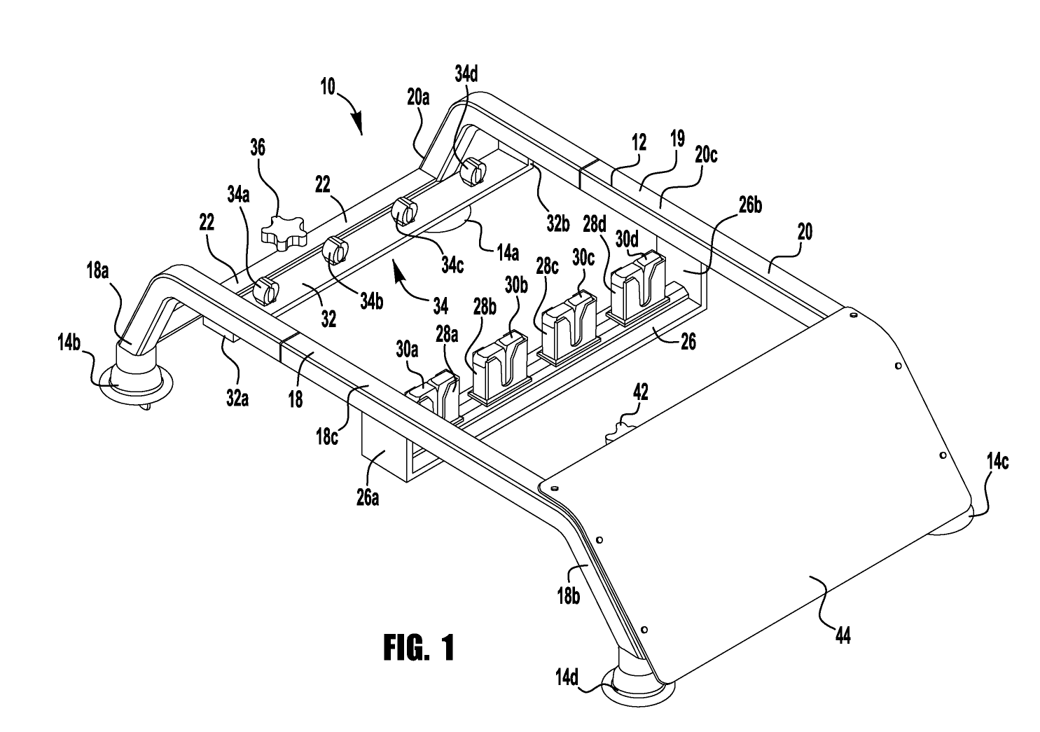

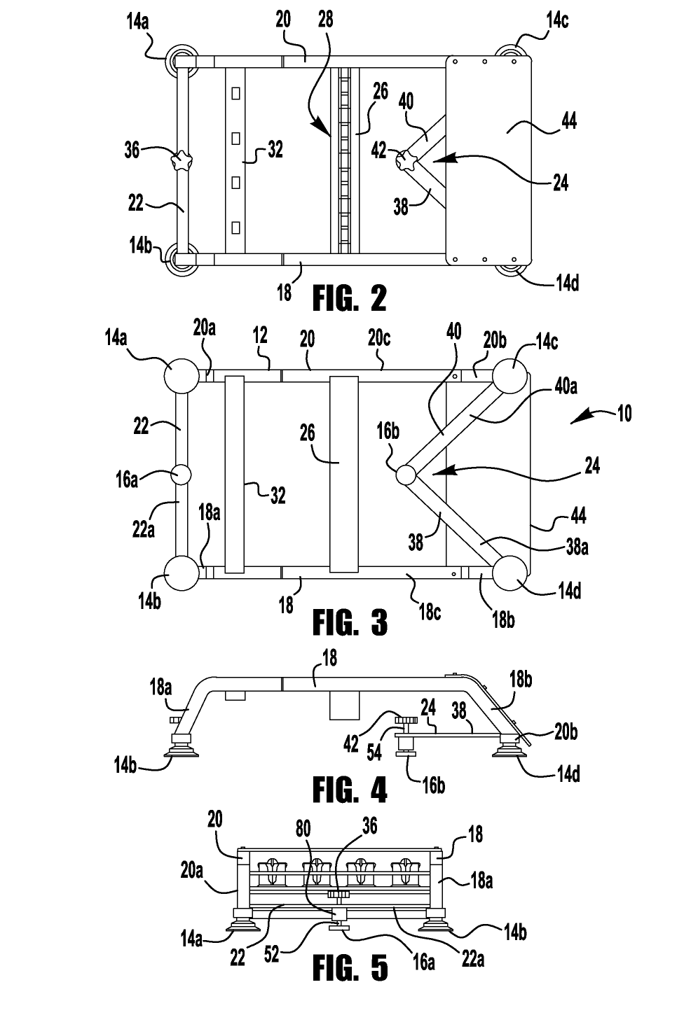

FIG. 1 illustrates a front, three-dimensional view of the fishing rod and reel carrier (hereafter “carrier”) 10. The function of the carrier 10 is to store or display one or more fishing rods and reels, as well as to transport the rods and reels on a motor vehicle or a marine vessel. In general terms, the carrier 10 is designed as a roof top carrying device for automotive vehicles, and more particularly, to a fishing rod holder for automotive vehicles. The principal object of the carrier 10 is to provide a fishing rod holder for automotive vehicles, which will be easily attached to, and removed from the tops of cars, trucks, and the like. Further, carrier 10 may be separated from the car top and carried as a portable unit to the ultimate fishing site. The unit can be transported as a whole without dismounting individual rod and reels but also remounts to a wall, ceiling, boat, or car allowing the user to disengage or engage individual rods at will. The carrier 10 is also constructed so that the fishing equipment can be carried completely assembled so that the fisherman is ready to fish when the rods and reels are removed from the carrier.

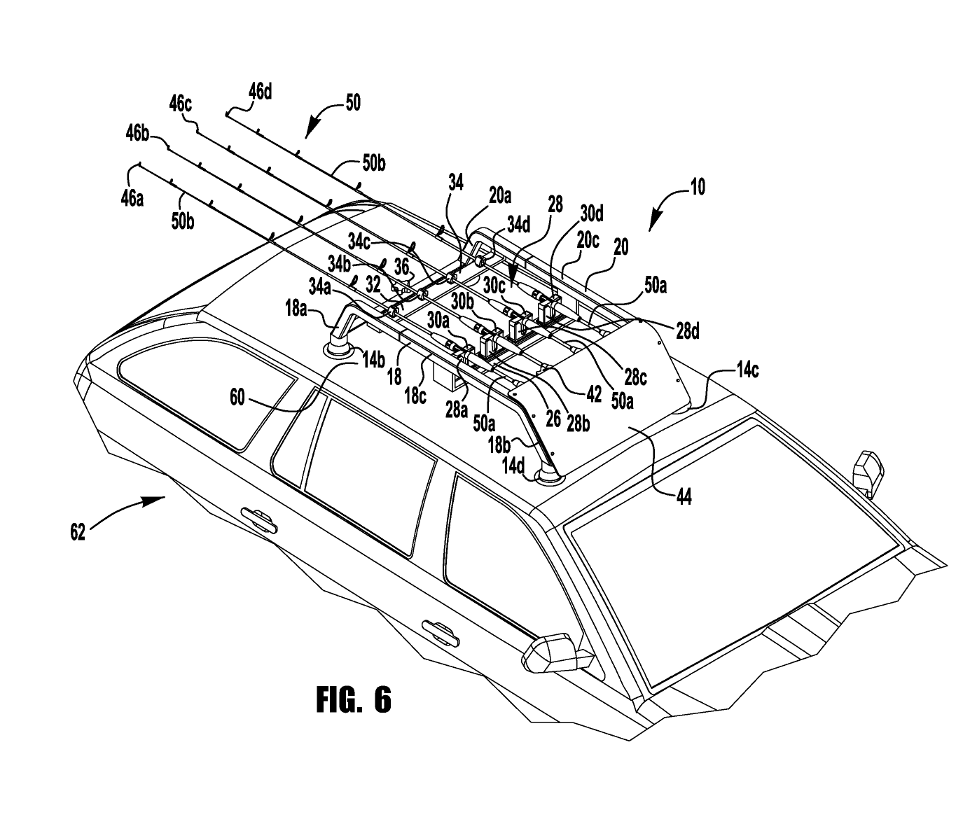

Carrier 10 consists of a carrier frame 12, which mounts on a conventional, ferromagnetic roof 60 of an automobile 62 (as seen in FIG. 6) with a plurality of suction cups 14, such as suction cups 14a, 14,b, 14c, and 14d (14a-14d) and a plurality of magnets 16, such as first and second magnets 16a and 16b, as seen in FIG. 3. The carrier frame 12 provides a rigid mounting structure on which to mount the fishing rods and reels 46a, 46b, 46c and 46d (46a-46d) for carry, transport, and mounting purposes. Preferably, carrier frame 12 is constructed of a lightweight but strong material, such as metal or a plastic polymer. Carrier frame 12 may have any suitable dimensions, such as a length of about 34 inches to about 40 inches and a width of about 20 inches to about 30 inches.

The structure of carrier frame 12, as best seen in FIG. 3, includes a first elongated support 18 and a parallel second elongated support 20, and two struts, rear strut 22 and front strut 24. Each of the two parallel, elongated supports 18 and 20 has two downward sloping leg sections. First parallel elongated support 18 contains downward sloping leg sections 18a and 18b, and second parallel elongated support 20 contains front and rear downward sloping leg sections 20b and 20a, as seen in FIG. 3. Rear strut 22 is attached, preferably by welding, to rear downward sloping leg section 18a of first parallel elongated support 18 and rear downward sloping leg section 20a of second parallel elongated support 20. Front strut 24 is attached, preferably by welding, to the first parallel elongated support 18 and to the second parallel elongated support 20.

At the bottom of each of the front downward sloping leg sections 18b and 20b, and rear front downward sloping leg sections 18a and 20a as best seen in FIG. 3, of the two parallel elongated supports 18 and 20, respectively, are suction cups 14d, 14c, 14b and 14a, respectively. Suction cups 14a-14d may be attached to the free end of the downward sloping leg sections 18a, 18b, 20a, and 20b in any appropriate manner, such as with an articulating joint. Suction cups 14a-14d are well known temporary locking mechanisms, which use negative pressure of air to adhere to nonporous surfaces, such as the roof of a vehicle, and in the process creates a partial vacuum. Suction cups 14a-14d are essential to providing the basis for hold-down strength to the roof 60 of the automobile 62, as seen in FIG. 6. It is within the terms of the preferred embodiment that suction cups 14a-14d be locking suction cups such as rotating lever actuated suction cups where rotating the levers in a first direction creates a strong, continuous hold and rotating the levers in the opposite direction breaks the suction. Locking suction cups are designed to enhance the hold of the carrier 10, onto the roof 60 of a vehicle 62. While suction cups with a rotating lever are described, it is within the terms of the preferred embodiment to use any type of locking mechanism and even suction cups without a locking mechanism may be utilized.

Suction cups 14a-14d are attached to the carrier 10 with articulating joints (not shown). Each articulated joint is comprised of a diamond shaped base plate that has been pressed in the center to provide an inset for a rounded head screw that fits up into the inset and runs through a finish washer and threads into the carrier frame 12. The countersunk/pressed inset fits up into the finish washer allowing a liberal amount of swivel in any direction allowing the suction cups 14a-14d to conform to the contour of a car roof 60. The base plate has two separate holes on the far corners which allows it to be mounted on the top of the suction cup. The articulating joint provides a link between the locking suction cups 14a-14d and the carrier 10 and allows sufficient adjustability to various roof 60 contours.

A first fishing rod support arm 26 extends between the two parallel elongated supports 18 and 20. First fishing rod support arm 26 is attached to the elongated supports 18 and 20 by two upstanding supports 26a and 26b, each of which are attached to first and section central sections 18c and 20c, respectively, of the elongated supports, respectively. Upstanding supports 26a and 26b suspend the support arm 26 approximately 1 inch to about 4 inches below central sections 18c and 20c.

Mounted upon first fishing rod support arm 26, as seen in FIG. 1, are a plurality of rod handle holders 28, such as rod handle holders 28a, 28b, 28c, and 28d (28a-28d). The rod handle holders 28a-28d and shaft holders (described below) grip the rods and retain them within the confines of the carrier 10 for display or transport while allowing rapid removal or insertion by the user with one hand. Rod handle holders 28a-28d each contain a gripping element 30a, 30b, 30c, and 30d (30a-30d), respectively, which temporarily secure the fishing rods. Each of the gripping elements 30a-30d consist of two sections of material, preferably rubber, which are tightly engaged against each other. When the fishing rod is pushed down between these two sections 30a-30d of rod handle holders 28a-28d, respectively, it is temporarily secured therein. When the user chooses to remove the fishing rod from between these two sections 30a-30d of rod handle holders 28a-28d, respectively, it is simply pulled out from between these two sections.

A second fishing rod support arm 32, as seen in FIG. 1, extends between the two parallel elongated supports 18 and 20. Second fishing rod support arm 32 is attached to the elongated supports 18 and 20 by two upstanding support 32a and 32b, each of which are attached to central sections 18c and 20c of the elongated supports, respectively. Two upstanding support 32a and 32b suspend the support arm 26 approximately 1 inch to about 4 inches below central sections 18c and 20c.

Mounted upon second fishing rod support arm 32 are a plurality of shaft holders 34, such as shaft holders 34a, 34b, 34c, and 34d (34a-34d). The shaft holders 34a-34d, are aligned with the rod handle holders 28a-28d, and grip the rods and retain them within the confines of the carrier 10 for display or transport while allowing rapid removal or insertion by the user with one hand. In a preferred embodiment, shaft holders 34a-34d may include a clamp of the type 28a-28d or a clip, as illustrated in FIG. 1, formed of two sections that can engage each other and form a narrow passageway designed to press a rod into the clamp and then pull the rod from the clamp to easily remove it. It is also within the terms of the preferred embodiment that the clamp or clip forms a closed opening into which the end of a fishing rod can be inserted. In either case, the clamp or clip 34a-34d allow the user to temporarily secure the fishing rods when engaged, but also allow for easy removal. Further, it is within the terms of the embodiment that there be a protective lining, such as rubber on the inner wall of the shaft holders 34a-34d to protect the fishing rods.

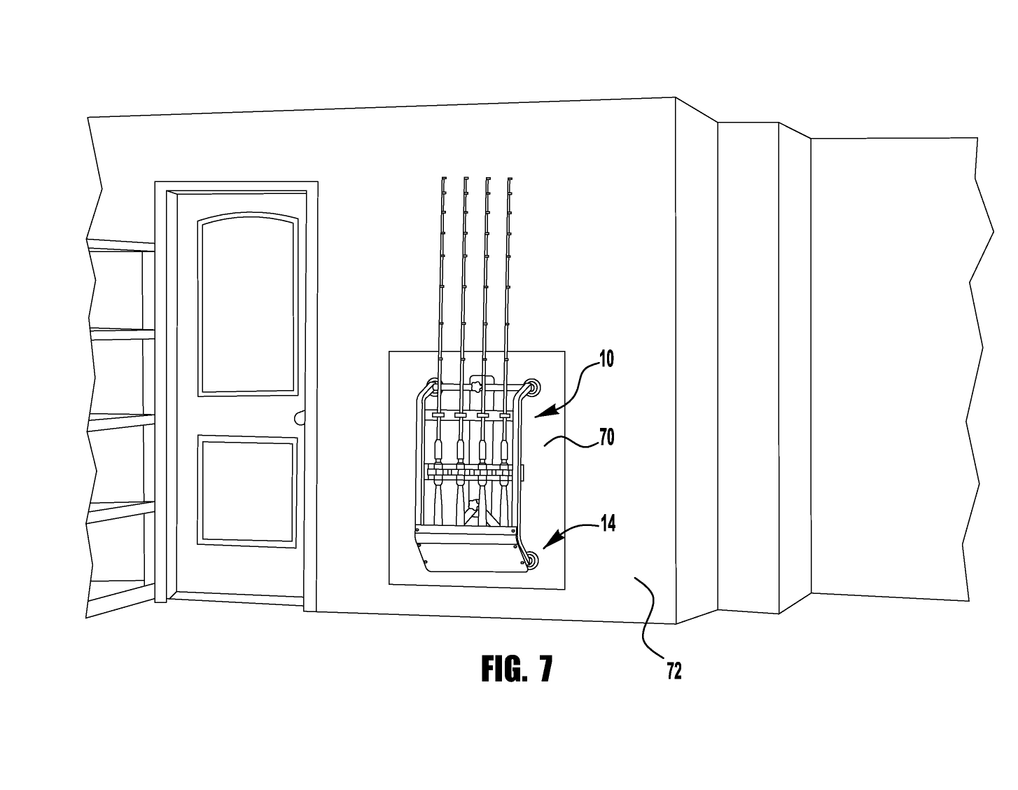

There is a plurality of permanent magnets 16a and 16b that are attached to the carrier frame 12 of carrier 10, as seen in FIG. 3. Although two magnets are illustrated, one or more magnets may be attached to the carrier frame to secure the carrier frame in place as discussed hereinafter. When the carrier frame 12 is mounted to the roof 60 of a motor vehicle 62 or a mounting plate 70 secured to a wall 72 or ceiling (not shown), the magnets 16a, 16b are removably attached to the ferromagnetic roof of the motor vehicle 62, as shown in FIG. 6, or to the mounting plate 70 secured to a wall or ceiling, as shown in FIG. 7. The magnets 16a,16b function to aid in keeping the suction cups 14a-14d secured to the ferromagnetic roof of a motor vehicle 62. The magnets 16a and 16b function to increase the degree of adherence of the carrier 10 to the vehicle roof. In operation, the magnets 16a, 16b cause the suction cups 14a-14d to tightly adhere to the roof 60 by drawing the magnets towards the carrier frame 12 after they have been in physical contact with the ferromagnetic roof.

Magnet 16a is disposed adjacent to the underside 22a of the rear strut 22, as seen in FIG. 5. Referring to FIGS. 5, 8 and 9, a magnet support housing 80 is shown for moving the magnet 16a away from rear strut 22 and then back towards the rear strut. The magnet support housing 80 is preferably a square or rectangular hollow tube 82 and is mounted to the underside 22a of strut 22 by means such as welding so that the opening at one end of the hollow tube abuts against the underside 22a of strut 22. The magnet support housing 80 includes an elongated, square or rectangular rod 84 disposed within the interior walls 82a of the square or rectangular hollow tube. The rod 84 is sized to allow it to move through the interior walls 82a without any rotational movement. A threaded bore 86 extends at least partially through the length of the rectangular rod 84. A threaded rod 52 is received within the threaded bore 86. One end of the threaded rod 52 extends through a circular opening in strut 22 and has a handle 36 affixed thereto. A permanent magnet 16a, typically having a cylindrical shape, is mounted to the lower end 84a of rod 84. Preferably, the permanent magnet 16a is mounted to the lower end 84a so that it does not rotate with respect to the handle 36.

Magnet 16b is disposed adjacent to the underside 24a of the front strut 24, as seen in FIG. 3. Referring to FIGS. 3, 8 and 9, a magnet support housing 80, which is identical with the one described with regard to FIG. 5 is shown for moving the magnet 16b away from front strut 24 and then back towards the front strut. The magnet support housing 80 is preferably a square or rectangular hollow tube 82 and is mounted to the underside of strut 24 by means such as welding so that the opening at one end of the hollow tube abuts against the underside of strut 24. The magnet support housing 80 includes an elongated, square or rectangular rod 84 disposed within the interior walls 82a of the square or rectangular hollow tube. The rod 84 is sized to allow it to move through the interior walls 82a without any rotational movement. A threaded bore 86 extends at least partially through the length of the rectangular rod 84. A threaded rod 52 is received within the threaded bore 86. One end of the threaded rod 52 extends through a circular opening in strut 24 and has a handle 42 affixed thereto. A permanent magnet 16b, typically having a cylindrical shape, is mounted to the lower end 84a of rod 84. Preferably, the permanent magnet 16b is mounted to the lower end 84a and does not rotate with respect to the handle 36.

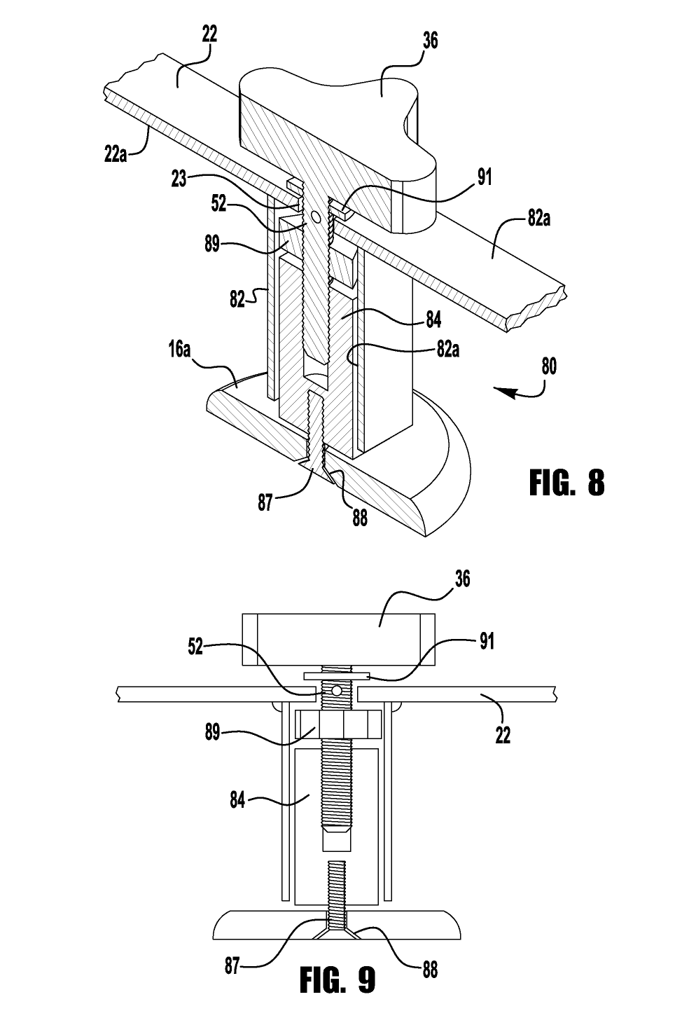

As shown in FIG. 9, a permanent magnet 16a (or 16b, as seen in FIG. 3) is mounted to the lower end 84a of rod 84. Each permanent magnet 16a has a countersunk circular opening 88 through which screw 87 fits loosely and extends upward to attach to rod 84, permitting magnet 16a to fit against the lower end of rod 84, yet rotate freely with respect to rod 84. There is space in between the magnet 16a and the rod 84 to allow for slight articulation to conform to various contours. The upper end of threaded rod 52 extends downward from attached handle 36 through a circular opening in strut 22 through a threaded nut 89 is secured by an adhesive or a locking nut at the threaded portion only leaving enough vertical clearance between the underside of handle 36 and the top of nut 89, so handle 36 can be rotated freely to move rod 84 up or down within hollow tube 82 without turning magnet 16a, yet adapting to minor variations of roof contours. A stop washer 91 serves to separate the handle 36 from the strut 22. This design functions so that when the handle 36 is turned in either direction to raise or lower the magnet 16a, the magnet does not tend to rotate, however due to the space between the magnet and the rod 84, the magnet can be turned manually if desired.

In operation, after the suction cups 14a-14d of the frame are mounted to the roof 60 of a motor vehicle 62 or a mounting plate 70, the magnets 16a and 16b are moved into contact with the roof or mounting plate by rotating the handles 36 and 42, respectively. Being that the rod 84 does not rotate in the hollow tube 82, the magnets contact the roof or mounting plate without any rotation. Also, when the handles 36 and 42 are moved in the opposite direction to retract the magnets 16a and 16b, the magnets do not rotate and therefore don't mar the finish on the roof or the mounting plate.

The magnets 16a, 16b, used in combination with the handles 36 and 42, respectively, allow the user to safely raise and lower the magnets 16a, 16b to the roof or wall mount at a controlled rate in order to keep from damaging the roof or magnet. When the handles 36 and 42 are turned in one direction, the magnets 16a and 16b, lower and then engage the roof 60 or wall mount 70. To withdraw the magnets 16a, 16b from the roof 60 or wall mount 70, the handles 36, 42 may simply be turned in the opposite direction to move the magnets towards struts 22 and 24.

A wind deflector 44 is mounted to the carrier frame 12 of carrier 10, as shown in FIG. 1, preferably using a plurality of conventional screws that connect to the downward sloping leg sections 18b and 20b of first and second parallel elongated supports 18 and 20, respectively. Typically, the wind deflector 44 can be constructed of any suitable material such as for example a plastic polymer. The wind deflector 44 serves to reduce wind noise while being transported on motor vehicle roofs and affords some protection for the carrier 10 from airborne debris.

FIG. 6 illustrates the carrier 10 in use. Carrier 10 is temporarily mounted to the roof 60 of automobile 62. Secured within carrier 10 are a plurality of fishing rods and reels 50, such that are commonplace items for fishing activities. Usually, the reels, not shown, are mounted on the fishing rods 50 for long periods, and are transported as a part of the rod assembly. As illustrated, the rod handle holders 28a-28d, as shown in FIG. 1, grip the rod handles 50a of the plurality of fishing rods 50 and shaft holders 34a-34d grip the shaft portions 50b of the fishing rods 50 and retain them within the confines of the carrier 10 for display or transport while allowing rapid removal or insertion with one hand.

FIG. 7 illustrates a separate, ferromagnetic wall mounting plate 70 which provides a docking point for carrier 10 when affixed to a wall or ceiling 72 (not shown). The carrier 10 is designed to attach to the mounting plate 70, using the magnets 16. The carrier is placed against mounting plate 70 and secured in place with the magnets 16. While the mounting plate 70 is shown to be larger than the footprint of the suction cups 14, it is within the terms of the preferred embodiment that the mounting plate only be large enough to receive the magnets 16. To remove the carrier 10 from the wall, the magnets 16 are retracted from the wall mounting plate 70.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A fishing rod and reel carrier for transporting and mounting one or more fishing rods and reels, comprising:
a carrier frame which mounts on a ferromagnetic surface;
a plurality of fishing rod holders mounted to the frame;
a plurality of suction cups secured to the frame to removably adhere the frame to the ferromagnetic surface; and
at least one magnet secured to the frame to removably attach to the ferromagnetic surface to aid in keeping the suction cups affixed to the ferromagnetic surface.

2. The fishing rod and reel carrier of claim 1 wherein the carrier frame includes:
first and second parallel elongated supports each having a front downward sloping leg section and a rear downward sloping leg section at opposite ends of the elongated supports; and
a front strut and a rear strut secured to the first and second parallel elongated supports.

3. The fishing rod and reel carrier of claim 2 wherein each of the plurality of suction cups is mounted to a free end of the front and rear downward sloping leg sections of the first and second parallel elongated supports.

4. The fishing rod and reel carrier of claim 1 wherein each of the plurality of suction cups is a locking suction cup.

5. The fishing rod and reel carrier of claim 4 wherein each locking suction cup is a lever actuated suction cup.

6. The fishing rod and reel carrier of claim 2 wherein the at least one magnet comprises:
a first permanent magnet mounted to the rear strut and disposed adjacent to an underside of the rear strut to removably attach to the ferromagnetic surface; and
a second permanent magnet mounted to the front strut and disposed adjacent to the underside of the front strut to removably attach to the ferromagnetic surface.

7. The fishing rod and reel carrier of claim 6 wherein:
the first and second magnets removably attach to the ferromagnetic surface without rotation.

8. The fishing rod and reel carrier of claim 7 wherein:
first and second magnet support housings each constructed of a rectangular hollow tube are mounted to the underside of the rear and front struts, respectively, so that an opening at one end of each hollow tube abuts against the underside of the rear and front strut;
the magnet support housings each include an elongated, rectangular rod having a threaded bore extending at least partially there through, the rectangular rod disposed within the hollow tube so that the rectangular rod moves through the hollow tube without rotational movement;
a threaded rod received within the threaded bore having one end of the threaded rod extending through a circular opening in the rear and front struts and a handle affixed thereto;
the first and second permanent magnets mounted to the lower end of the rod so that they do not rotate in respect to the handle.

9. The fishing rod and reel carrier of claim 2 wherein the fishing rod holders comprise:
a first fishing rod support arm mounted between the two parallel elongated supports; and
a second fishing rod support arm mounted between the two parallel elongated supports and spaced from the first fishing rod support arm.

10. The fishing rod and reel carrier of claim 9 wherein:
the first fishing rod support arm includes a plurality of rod handle holders that grip the fishing rods and retains them within the confines of the carrier; and
the second fishing rod support arm includes a plurality of shaft holders that are aligned with the rod handle holders and grip the fishing rods and retain them within the confines of the carrier.

11. The fishing rod and reel carrier of claim 10 wherein:
the rod handle holders each having a gripping element of two sections of material which are tightly engaged against each other and are disposed to allow the fishing rod to be pushed down between the two sections; and
the shaft holders each comprise a clamp aligned with the rod handle holders and formed of two sections that form a closed opening into which the end of a fishing rod can be inserted. The shaft holders may alternatively have a gripping element of two sections of material which are tightly engaged against each other and are disposed to allow the fishing to be pushed down between the two sections.

12. The fishing rod and reel carrier of claim 1 wherein the ferromagnetic surface is a top of a vehicle.

13. The fishing rod and reel carrier of claim 1 wherein the ferromagnetic surface is a wall mounting plate.

14. The method of transporting and mounting one or more fishing rods and reels on a fishing rod and reel carrier, comprising:
mounting a carrier frame on a ferromagnetic surface;
providing a plurality of fishing rod holders mounted to the frame;
removably adhering the frame to the ferromagnetic surface with a plurality of suction cups secured to the frame; and
removably attaching the frame to the ferromagnetic surface with at least one magnet secured to frame to aid in keeping the suction cups affixed to the ferromagnetic surface.

15. The method of claim 14 including mounting the frame to the ferromagnetic surface and securing the frame to the ferromagnetic surface with locking suction cups mounted to the frame.

16. The method of claim 14 including:
providing a first magnet mounted to the frame;
providing a second magnet mounted to the frame;
engaging the ferromagnetic surface with the first and second magnets;
moving the first and second magnets towards frame without rotation to ensure the suction cups are secured to the ferromagnetic surface.

17. The method of claim 16 including:
providing a first fishing rod support arm on the frame with a plurality of rod handle holders each having a gripping element of two sections of material which are tightly engaged against each other;
providing a second fishing rod support arm on the frame with a plurality of shaft holders each being a clamp aligned with the rod handle holders and formed of two sections that form a closed opening; and
mounting one or more fishing rods to the fishing rod and reel carrier by:
inserting the end of at least one of the fishing rods into one of the shaft holders; and
pressing the handle of at least one of the fishing rods between the two sections of the rod handle holders.

18. The method of claim 17 including:
removing the one or more fishing rods from the fishing rod and reel carrier by:
pulling the handle of at least one of the fishing rods from between the two sections of the rod handle holders; and
removing the end of at least one of the fishing rods from the shaft holders.

19. The method of claim 16 including removably attaching the frame to the ferromagnetic surface of a vehicle with the plurality of magnets secured to the frame engaging the surface of the vehicle to aid in keeping the suction cups affixed to the ferromagnetic surface of the vehicle.

20. The method of claim 16 including removably attaching the frame to a ferromagnetic wall mounting plate with the plurality of magnets secured to the frame engaging the wall mounting plate.
